(19) United States
(12) Patent Application Publication
(10) Pub. No.: US 2025/0209222 A1
(43) Pub. Date: Jun. 26, 2025

(54) METHOD FOR PRODUCING AN AMORPHOUS ARCHITECTURE OF THE MICRO-LATTICE TYPE FORMED OF MICRO-BEAMS CONNECTED TOGETHER BY NODES

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(72) Inventors: Antoine MONTIEL, Gif-sur-Yvette (FR); Daniel BONAMY, Gif-sur-Yvette (FR); Cindy ROUNTREE, Gif-sur-Yvette (FR); Paul SARGUEIL, Gif-sur-Yvette (FR); Valérie GEERTSEN, Gif-sur-Yvette (FR); Patrick GUENOUN, Gif-sur-Yvette (FR); Thuy NGUYEN, Bourg la Reine (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(21) Appl. No.: 18/847,034

(22) PCT Filed: Mar. 14, 2023
(86) PCT No.: PCT/EP2023/056515

§ 371 Date: Sep. 13, 2024

(30) Foreign Application Priority Data
Mar. 14, 2022 (FR) 2202194

(51) Int. Cl. G06F 30/10; B33Y 10/00; B33Y 50/02; B33Y 80/00; G06F 113/10

(52) U.S. Cl. CPC G06F 30/10; B33Y 10/00; B33Y 50/02; B33Y 80/00; G06F 2113/10

(57) ABSTRACT

The invention relates to a method for producing an amorphous three-dimensional architecture of the micro-lattice type formed of micro-beams connected together by nodes, which comprises: A) performing (100) a computer-implemented design step consisting, on the basis of a three-dimensional random arrangement (INIT) of non-deformable beads, in: a) producing (101) a three-dimensional random compact stack of said beads; b) for each bead, determining (102) the coordinates of the centre of the bead which correspond to those of a node; c) performing (103) a triangulation with said nodes, each triangle thus being defined with the nodes closest to one another, then associating two nodes connected by one side of a triangle to a micro-beam in order to define the micro-lattice; d) selecting (104) a sub-domain of the micro-lattice obtained in step c), not comprising the nodes located at the edge of the micro-lattice in order to define said amorphous three-dimensional architecture, the design step involving an average connectivity of the nodes greater than or equal to twelve, the design step providing for defining a shape and associated transverse dimensions for each micro-beam; and B) producing (200) the architecture designed in step A).

### TECHNICAL FIELD OF THE INVENTION

The invention relates to the field of cellular materials, and more particularly to materials with a micro-lattice type architecture, which is formed of micro-beams connected together by nodes.

### TECHNICAL BACKGROUND

Environmental, cost, access to raw materials and recycling constraints mean that raw materials must be used as sparingly as possible in the production of structural materials. A widely explored approach is therefore to reduce the density ρ (or specific gravity) of materials as much as possible without affecting their mechanical behavior. The mechanical behavior of the material is defined in particular by its rigidity, its hardness and its resistance to fracturing.

The most natural way to lighten a material is to introduce pores. Pores may be introduced into the material at random.

Examples comprise solid foams and aerogels. These are highly porous solids and therefore very light. They therefore have many applications in industry, but their high porosity means that their mechanical strength is drastically reduced. Typically, a solid foam with a relative density of 1% (with reference to the solid material) has a rigidity 106 times lower than that of the material of which it is made. The rigidity changes with the cube of the density. In other words, the ratio between rigidity and density evolves with the square of the density and is therefore divided by approximately 10,000 when going from a solid material to a solid foam made of this material with a relative density of 1%.

However, the random introduction of pores has the advantage that there are no statistically preferred orientations and the mechanical behavior is generally isotropic. It is therefore possible to use the usual constants (Young's modulus E and Poisson's ratio v to define its rigidity, yield strength σ_{γ} to define its hardness and fracture toughness Kc to define its resistance to fracturing) to mechanically characterize the material thus formed. These standard constants may be used to predict the mechanical behavior of structures, irrespective of the geometry of the structures and the stress exerted on them.

Alternatively, pores may be introduced into the material in a controlled manner.

In particular, this control may be achieved by means of an additive manufacturing. The additive manufacturing allows to modulate the architecture of the material in extenso, and therefore to arrange the pores in the space in a controlled way, thereby significantly improving mechanical performance.

For example, see the article by T. A. Schaedler & al.: Ultralight Metallic Microlattices, Science, 334(6058), 962-965 (2011) which proposes a micro-lattice type architecture wherein the micro-beams are hollow tubes arranged periodically. As may be seen in this article (FIG. 4), this allows to keep the ratio between the rigidity and the density at relatively high levels.

The rules for controlling this rigidity-density ratio in a micro-lattice made of periodically arranged micro-beams are well known.

To do this, we need to control the connectivity referred to as Z, i.e. the number of micro-beams per node. If the connectivity Z is less than 6, the rigidity varies with the square of the density. If the connectivity Z is greater than or equal to 12, the rigidity is substantially proportional to the density. Thus, for a micro-lattice with a connectivity of Z=12 (the best-known example is the micro-lattice known in the literature as an “octet-truss”), the rigidity of the architecture with a relative density of 1% (with reference to the solid material) is only degraded by a factor varying between 300 and 1000 compared with that of the material of which it is made. This information may be found in the article by V. S. Despandes & al: Foam topology: bending versus stretching dominated architectures, Acta Materialia, 49(6), 1035-1040 (2001) and V. S. Despandes & al: Effective properties of the octet-truss lattice material, Journal of the Mechanics and Physics of Solids, 49, 1747-1769. For a relative density of 1%, the performance in terms of the evolution of the rigidity-density ratio is therefore 10 to 30 times better than that obtained with a random architecture with globally isotropic mechanical behavior (solid foam).

However, the periodicity has a major disadvantage in that the mechanical behavior of the resulting micro-lattice is anisotropic. The material is less rigid or more brittle when stressed in certain directions. It is this difference in mechanical behavior depending on the direction of stress that is reflected in the range of values given above for the rigidity-to-density factor between 300 and 1000.

Because of this anisotropy, it is no longer possible to define the material solely by the usual constants (Young's modulus, Poisson's modulus, yield strength and toughness) used to dimension the structures.

Some authors have studied the impact of imperfections on the mechanical performance of micro-lattice wherein the micro-beams are arranged periodically.

To this end, it has been proposed to start with a micro-lattice wherein the micro-beams are arranged periodically and to modify this structure to make it more random. This was achieved by moving the nodes of a micro-lattice over a certain distance and in a randomly chosen direction, or by eliminating a certain proportion of randomly chosen micro-beams from the micro-lattice. It is well known that adding disorder promotes isotropy. Although the micro-lattice with a periodic architecture that is disordered in this way exhibit more isotropic mechanical behavior (the level of isotropy depending on the level of disorder introduced), the rigidity nevertheless deteriorates as the disorder introduced increases.

These approaches, aimed at disordering to a greater or lesser extent the architecture of an initially periodic micro-lattice, therefore allow to partially improve the isotropy properties at the cost of a deterioration in the rigidity. A compromise must therefore be found. One aim of the invention is to define an architecture that has both a globally isotropic mechanical behavior and good mechanical performance.

To this end, the invention proposes a method for producing an amorphous three-dimensional architecture of the micro-lattice type formed of micro-beams connected together by nodes, comprising the steps following:
A) performing a computer-implemented design step consisting, on the basis of a three-dimensional random arrangement of non-deformable beads of given diameters, in:
a) producing a three-dimensional random compact stack of said beads,
b) for each bead in the three-dimensional random compact stack, determining the coordinates of the center of the bead and then associate these coordinates with those of a node,
c) performing a triangulation with the nodes defined in this way so that each triangle is defined with the nodes closest to each other, then associating two nodes connected by one side of a triangle to a micro-beam to define the micro-lattice,
d) selecting a sub-domain of the micro-lattice obtained in step c), this sub-domain not comprising the nodes located at the edge of this micro-lattice, in order to define the amorphous three-dimensional micro-lattice architecture, the design step involving an average connectivity of the nodes of the micro-lattice greater than or equal to twelve, the design step also involving defining a shape and associated transverse dimensions for each micro-beam, then:
B) producing the architecture designed in step A).

This method results in an amorphous micro-lattice type architecture whose behavior is then globally isotropic and for which the usual constants for defining a material may be defined (Young's modulus, Poisson's ratio, elastic limit and toughness). The amorphous nature of the micro-lattice type architecture is due, on the one hand, to the fact that the method is implemented using a random arrangement of non-deformable beads, the random nature of which is consubstantial with the production method and, on the other hand, to the fact that the method comprises steps designed to homogenize the lengths of the micro-beams within the micro-lattice architecture. In addition, the mechanical performances obtained with this architecture are far superior to those observed in micro-lattice with isotropic mechanical behavior known to date.

Thus, unlike the approach used in the prior art, where the aim is to introduce imperfections into a micro-lattice with an initially periodic architecture, there is no compromise to be found in the context of the invention between isotropic behavior of the micro-lattice architecture and mechanical performance.

The method according to the invention may comprise at least one of the following additional steps, taken alone or in combination:
step A) is implemented using a random arrangement of beads of identical diameters;
step a) is implemented by a Lubachevsky-Stillinger algorithm, referred to as force bias algorithm, an algorithm derived therefrom, or any succession of these different algorithms;
the triangulation carried out in step c) is a Delaunay triangulation;
the method comprises a step, implemented after step d) and consisting in producing a lattice of the micro-lattice obtained in step d) before implementing step B);
step B) is produced by additive manufacturing.

The invention also relates to an amorphous three-dimensional architecture of the micro-lattice type, the micro-lattice being formed of micro-beams connected to one another by nodes and wherein each micro-beam forms one side of a triangle connecting the nodes closest to one another with an average connectivity of the nodes greater than or equal to twelve.

This architecture is advantageously obtained by the method described in the invention. The architecture may also comprise at least one of the following characteristics, taken alone or in combination:
the statistical distribution of the length of the micro-beams has a standard deviation to mean ratio of less than or equal to 0.3;
the statistical distribution of the length of the micro-beams has a standard deviation to mean ratio of less than or equal to 0.2;
each micro-beam is in the form of a cylinder of given diameter.

### BRIEF DESCRIPTION OF THE FIGURES

Further objects and characteristics of the invention will become clearer in the following description, made with reference to the attached figures, wherein:

FIG. 1 is a schematic representation of the main steps of a method according to the invention for the produce of a micro-lattice formed from micro-beams connected together by nodes;

FIG. 2 represents a compact three-dimensional random stack of non-deformable beads of identical diameters, obtained after a first step of the method according to the invention has been implemented by computer on the basis of a compact random arrangement of said beads;

FIG. 3 represents a cloud of nodes obtained after implementing by computer a step of the method according to the invention performed on the basis of the arrangement in [FIG. 2];

FIG. 4 represents the micro-lattice obtained after computer implementation of another step in the method according to the invention using the cloud of nodes shown in [FIG. 3];

FIG. 5 represents a statistical distribution of the number of micro-beams as a function of their length for the micro-lattice shown in [FIG. 4];

FIG. 6 is a histogram representing the number of nodes associated with a given connectivity of this node, for different values of this connectivity and for the micro-lattice represented in [FIG. 4].

FIG. 7 shows the architecture finally obtained after an additional step in the method according to the invention has been implemented by computer using the micro-lattice of [FIG. 4];

FIG. 8 represents a statistical distribution of the number of micro-beams as a function of their length for the architecture shown in [FIG. 7];

FIG. 9 is a histogram representing the number of nodes with a given connectivity, as a function of the value of this connectivity and for the architecture represented in [FIG. 7];

FIG. 10 represents the architecture obtained after a final, optional, computer-implemented step in the method according to the invention, consisting of producing a lattice, for example using a computer-aided design (CAD) tool, of the architecture shown in [FIG. 7];

FIG. 11 represents the architecture obtained after a final step of the method according to the invention, consisting of producing the architecture of [FIG. 10];

FIG. 12 provides numerical results based on an architecture similar to that shown in [FIG. 11] to determine its mechanical performance.

### DETAILED DESCRIPTION OF THE INVENTION

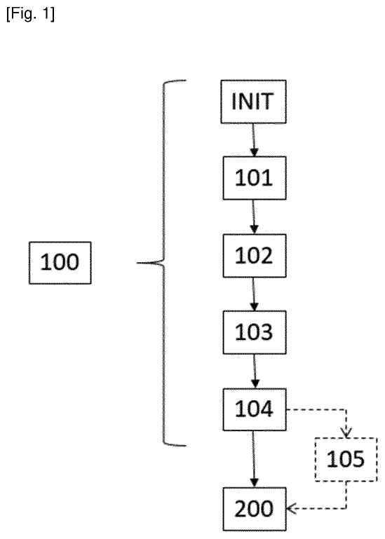

FIG. 1 is a schematic representation of the various steps of the method according to the invention.

The invention relates to a method for producing an amorphous three-dimensional architecture of the micro-lattice type, the micro-lattice being formed of micro-beams connected together by nodes, which comprises a step 100 of computer-aided design of the architecture and a step 200 of producing the architecture thus designed.

The design step starts INIT with a three-dimensional random arrangement of non-deformable beads of given diameters, and then performs the following steps:
producing 101 a three-dimensional random compact stack of said beads,
for each bead in the three-dimensional random compact stack, determining 102 the coordinates of the center of the bead and then associate these coordinates with those of a node,
producing 103 a triangulation with the nodes defined in this way so that each triangle is defined with the nodes closest to each other, then, associate two nodes connected by a side of a triangle to a micro beam to define the micro-lattice,
selecting 104 a sub-domain of the micro-lattice obtained in step 103, this sub-domain not comprising the nodes situated at the edge of this micro-lattice, so as to define the amorphous architecture of the micro-lattice type, and, optionally:
producing 105 a lattice representative of the architecture obtained in step 104;
the design step also defining a shape and associated transverse dimensions for each micro-beam.

We will explain this method with the help of an example of embodiment.

Initially, the starting point is a three-dimensional random arrangement of non-deformable beads. The term beads covers either a ball (solid) or a sphere (hollow) in the mathematical sense of the term.

These beads each have a given diameter. It is important to be able to fix these diameters as they determine the length of the micro-beams in the method described in the invention. The diameter of the different beads is not necessarily identical.

However, it is advantageous to start from an arrangement with beads having close diameters, typically with a variation of no more than 30% in relation to a mean value, or identical to minimize the standard deviation from the mean length of the micro-beams present in the micro-lattice that we are seeking to produce. The homogeneity of the length of the micro-beams, together with the random nature of the distribution of the beads within the compact three-dimensional stack of beads, helps to define an amorphous architecture. From this initial state, the aim of the step 101 is to obtain a three-dimensional random compact stack of beads.

There are various types of algorithm in the literature for obtaining this type of stack. For example, it is possible to use a Lubachevsky-Stillinger algorithm, a force-biased algorithm, an algorithm derived from these, or any combination of these algorithms.

The Lubachevsky-Stillinger algorithm is widely known and has been the subject of numerous publications. For further information, see the article by Lubachevsky, Boris D.; Stillinger, Frank H. (1990): Geometry properties of random disk packings, Journal of Statistical Physics, 60 (5-6): 561-583.

The force-biased algorithm is also widely known and has been the subject of numerous publications. For further information, see J. Moscinski, M. Bargiel, Z. A. Rycerz & P. W. M. Jacobs (1989) The Force-Biased Algorithm for the Irregular Close Packing of Equal Hard Spheres, Molecular Simulation, 3:4, 201-212.

Here is the procedure used in this example to generate the initial INIT three-dimensional random arrangement of beads and implement step 101.

We used the algorithm developed by Vasili Baranau, available at https://github.com/VasiliBaranov/packing-generation (distributed under MIT licence).

The user must specify as input: 1) the size of the container containing the stack, 2) the diameters of the beads, 3) the number of iterations of the algorithm, 4) the contraction rate, 5) an integer used as a seed for the pseudo-random number generator.

The cubic container was chosen with a side size of 11.7 (arbitrary dimension). This is the size of the container before the beads are compacted.

The beads were chosen with identical diameters, of value 1 (arbitrary dimension). 1,075 beads were taken into consideration.

100 iterations were performed.

The contraction rate was chosen to be 0.1 (arbitrary unit). The lower the rate of contraction, the more compact the stack of beads will be.

The integer used as the seed for the pseudo-random number generator was chosen at random. The algorithm uses this seed to generate the initial positions of the beads in the container.

The algorithm (called PackingGeneration.exe) is then run in “fba” mode (this is a “Forced-Biased” algorithm). The pre-stack obtained after running this algorithm is given in a packing.xyzd file containing the positions X, Y and Z and diameters D of each bead. This packing.xyzd file is backed up by another packing.nfo file containing various parameters characteristic of the pre-stack (e.g. compactness).

We then use these last two files as inputs to the same algorithm (PackingGeneration.exe) but run in “Is” mode (indicating a Lubachevsky-Stillinger algorithm). We then obtain a new packing.xyzd file containing the positions X, Y, Z and the diameters D updated after compaction and also a new packing.nfo file comprising information on the pre-stacking thus obtained.

We use these new packing.xyzd and packing.nfo files as inputs to the same algorithm (PackingGeneration.exe) but now in “Isgd” mode (an algorithm derived from the Lubachevsky-Stillinger algorithm, with an option referred to as gradual densification). At this stage, the packing.xyzd file contains the positions and diameters of the beads in the three-dimensional random compact stack and the file contains various information about the stack and, in particular, its compactness. The compactness obtained in this example is 0.6345. It is therefore clear that several different compaction algorithms are used in succession to obtain the three-dimensional random compact stack. The aim is to achieve the highest possible compactness, typically between 0.6 and 0.64 in three dimensions. A high degree of compactness is important to ensure good mechanical performance, for example in terms of the rigidity (E/p ratio in particular) of the micro-lattice to be produced.

Finally, the coordinates X, Y, Z of the center of each bead were modified in the packing.xyzd file, by dividing the values mentioned by a rescaling factor F defined as follows:

$$F = {( \frac{1 - {p}_{fin}}{1 - {p}_{th}} )}^{\frac{1}{3}} \qquad [ Math 1 ]$$

wherein the parameters β_{fin} and ρₜₕ are both given in packing.nfo. In this case, the scaling factor F is F=1.0842. The implementation of this correction is linked to the implementation of the computer program chosen to illustrate the method according to the invention, but there is nothing systematic about implementing step 101 of the method according to the invention.

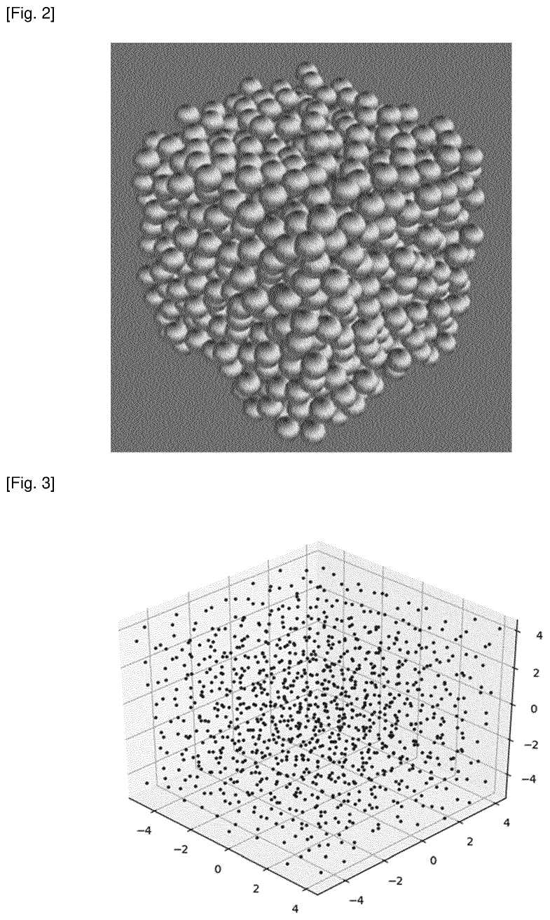

FIG. 2 shows the compact three-dimensional random stack of beads of identical diameters obtained after computer implementation of this first step 101 of the method according to the invention

Next, step 102 consists of determining the coordinates of the center of the bead for each bead in the three-dimensional random compact stack and associating them with a node. In this case, the coordinates of the center of each bead are available in the packing.xyzd file obtained at the end of step 101. All you have to do is extract them from this file and put them in a dedicated file where they are associated with the nodes of the micro-lattice you are trying to produce.

FIG. 3 shows the three-dimensional node cloud obtained after computer implementation of step 102.

Then, in step 103, a triangulation is performed with the nodes thus defined (three-dimensional point cloud in FIG. 3).

The triangulation is used to achieve the highest possible connectivity Z of the nodes, i.e. the number of micro-beams per node. The triangle is in fact the lowest-order non-degenerate polygon. Any higher-order polygon (quadrilateral, pentagon, etc.) will offer fewer possibilities for the connectivity of the nodes. We know that it is important to have a high level of connectivity in the architecture, and advantageously at least 12 in three dimensions, in order to maintain good mechanical properties, particularly with regard to the rigidity (E/ρ ratio).

In the context of the invention, the triangulation is also performed with the nodes closest to each other in the three-dimensional cloud of nodes obtained at the end of step 102. Defining the triangles with the closest nodes means that the length of the sides of each triangle remains consistent. This homogeneity is important because, as we will see later in the description, it defines the homogeneity of the length of the micro-beams. Defining micro-beams with homogeneous lengths (low dispersion) within the micro-lattice to be produced is important for obtaining good mechanical properties, particularly with regard to the rigidity (E/ρ ratio). This homogeneity, together with the random nature of the bead distribution within the compact three-dimensional bead stack, helps to define an amorphous architecture. Several types of triangulation are possible.

A widely used triangulation is the Delaunay triangulation.

A Delaunay triangulation was implemented in the following example of embodiment. To be more precise, please refer to the following document which gives the algorithm: https://docs.scipv.org/doc/scipvzreference/generated/scipv.spatial.Delaunav.html (Python). This is what is used in the example of embodiment described here.

Among the other possible triangulations, we may generalize to the various regular triangulations, of which the Delaunay triangulation is only a special case. A Pitteway triangulation may also be considered.

Then, to define the micro-lattice, all you have to do is associate two nodes connected by a side of triangle to a micro-beam in a dedicated file.

The length of a micro beam is then entirely determined by the distance between two nodes belonging to the same triangle. The distance separating two nodes belonging to the same triangle is itself defined by the selected diameter of the beads prior to implementation of the method according to the invention and step 101 for producing the three-dimensional random compact stack.

The cross-sectional shape of the micro-beams and the associated transverse dimensions are data supplied independently.

In particular, once the shape of the cross-section has been fixed (e.g. circular to form cylindrical micro-beams), determining the transverse dimensions (this is reduced to the diameter for cylindrical micro-beams) allows the final relative density of the micro-lattice to be set. These transverse dimensions may differ from one micro-beam to another. However, the choice of an identical cross-sectional shape with the same transverse dimensions for all the micro-beams allows to control easily the relative density of the architecture we are seeking to build. So if these transverse dimensions are significantly smaller than the length of the micro-beams (a situation allowing to obtain a low relative density), the relative density of the architecture that will be produced evolves as the square of the ratio between this transverse dimension and the average length of the micro-beams.

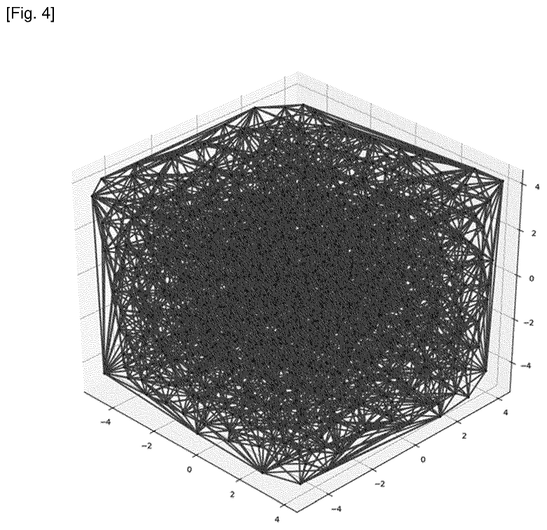

The shape and transverse dimensions of the micro-beams may be defined at various points during design step 100. This information is only useful for the actual producing method. FIG. 4 shows the micro-lattice obtained at the end of step 103.

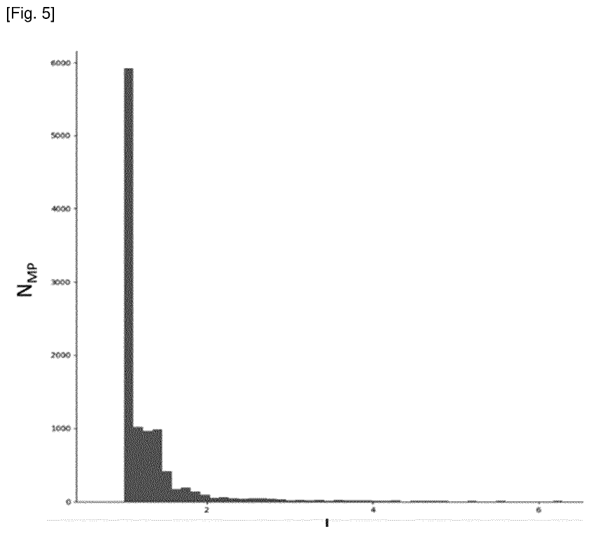

FIG. 5 shows the statistical distribution of the number of micro-beams NMp as a function of their length L_{MP} for the micro-lattice shown in FIG. 4. There was a wide spread in the diameter of the beads in relation to the unit length (unit diameter=diameter of the beads chosen initially). Longer micro-beams exist, in large quantities up to lengths of 2 and even, albeit in smaller quantities, up to lengths of more than 6. More specifically, the results shown in FIG. 5 are characterized by a statistical distribution of the length of the micro-beams with a standard deviation to mean ratio of 0.568.

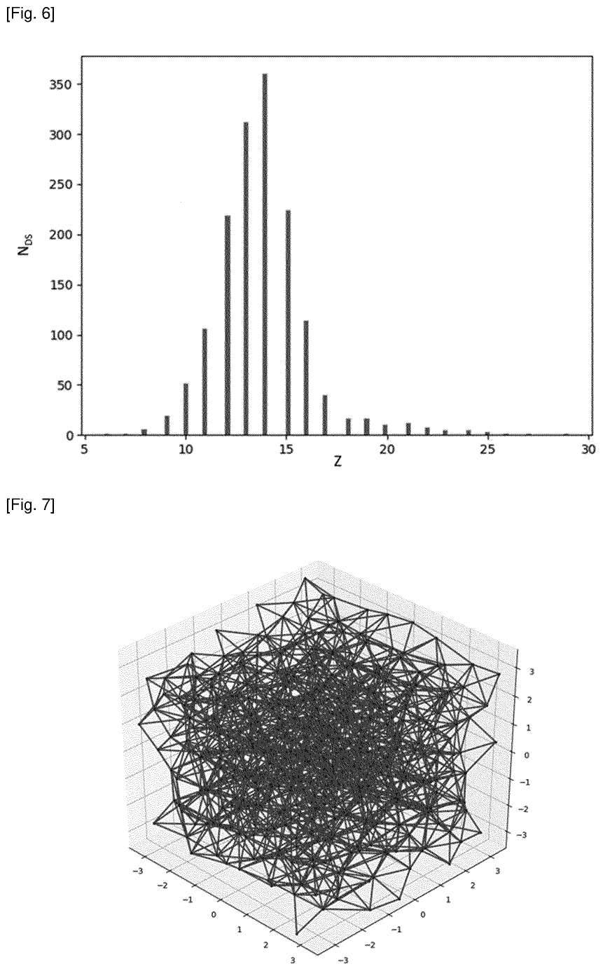

FIG. 6 is a histogram representing the number of nodes N_{CS} associated with a given connectivity Z of this node, for different values of this connectivity and for the micro-lattice represented in FIG. 4. The nodes on the edges of the micro-lattice were taken into account. As may be seen in FIG. 6, the nodes have a high average connectivity, which is a consequence of the triangulation, of between 13 and 14, i.e. well above or equal to 12. However, there is a wide spread, with nodes with connectivity between 5 and 30, and mainly between 8 and 20.

Next, a step 104 consisting of selecting a sub-domain of the micro-lattice obtained in step 103, this sub-domain not comprising the nodes located at the edge of this micro-lattice, is implemented in order to finally define the three-dimensional amorphous micro-lattice architecture. In fact, FIG. 4 shows edge effects which mean that certain triangles, located at the edges of the micro-lattice, have sides whose length is very different from the average length of a triangle side.

The selection of this sub-domain therefore allows to avoid the inclusion in the material of elements that are longer than the average length and therefore increases the homogeneity of the length of the micro-beams. It should be remembered that this homogeneity contributes, along with the random nature of the distribution of the beads within the compact three-dimensional stack of beads, to defining an amorphous architecture, with its consequences on isotropic mechanical behavior and high mechanical characteristics. However, it should also be noted that the implementation of this step 104 ultimately allows to obtain a micro-lattice with a rigidity maintained at the edge, which is obviously of great interest for a real structural part.

In this example, the sub-domain chosen is a cubic sub-domain whose center coincides with the center of the micro-lattice (also cubic) in FIG. 4, but wherein each dimension X, Y and Z of the space is reduced by a quarter (in FIG. 7, the dimensions range from −3 to +3, whereas they range from −4 to +4 in FIG. 3).

The resulting micro-lattice is shown in FIG. 7.

As may be seen in FIG. 7, this eliminates the edge effects.

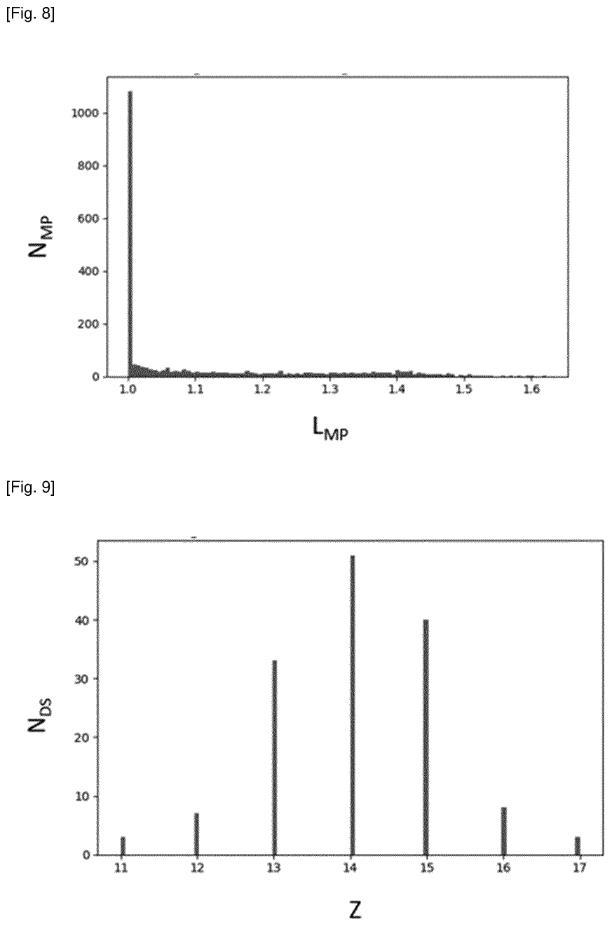

FIG. 8 shows the statistical distribution of the number of micro-beams NMP as a function of their length L_{MP} for the micro-lattice shown in FIG. 7. It may be seen that almost all the micro-beams have a uniform length (=the diameter of the beads chosen initially). Longer micro-beams exist, up to lengths of around 1.5, but in very small proportions. The length of the micro-beams is therefore homogeneous throughout the micro-lattice shown in FIG. 7. More specifically, the results shown in FIG. 8 are characterized by a statistical distribution of the length of the micro-beams with a standard deviation to mean ratio of 0.136. Incidentally, the selection of this sub-domain also has an effect on the connectivity of the nodes.

FIG. 9 is a histogram representing the number of nodes Nos associated with a given connectivity Z of this node, for different values of this connectivity and for the micro-lattice represented in FIG. 7. In this figure, the nodes on the edges of the micro-lattice have significantly lower connectivity than the others and have not been taken into account. As may be seen in FIG. 9, all the nodes retained in this way have a high level of connectivity. In fact, the vast majority of nodes have a connectivity Z of at least 12, with connectivity most often of Z=13 or Z=14. The average connectivity value is therefore always greater than or equal to 12. We may also see that the connectivity is not too high either, which is a good thing since too high a connectivity, i.e. above Z=12, is of no real interest in terms of the mechanical behavior of the micro-lattice.

The design of the amorphous micro-lattice architecture is now complete.

All that then needs to be done is to implement a step 200 for producing the architecture obtained in step 104.

Depending on the producing method used, it may be necessary to implement an additional step during the design step 100 consisting of producing 105 a lattice representative of the micro-lattice obtained in step 104. This lattice is typically produced using computer-aided design (CAD) software. This is the case, for example, if step 200 of the producing method is performed using additive manufacturing. Step 105 may also be used to define a shape and associated transverse dimensions for each micro-beam, for example a cylinder shape with its diameter defined.

An amorphous architecture of the micro-lattice type obtained in accordance with the method according to the invention was produced by implementing steps 101 to 104 as described previously in support of the example of embodiment presented previously, with the difference that the final shape of the architecture is here chosen to be parallelepipedic and not cubic. This choice was made when defining the sub-domain of the micro-lattice in step 104. We also had to choose a bead diameter, with a non-arbitrary value for producing, to determine the length of the micro-beams.

In this case, step 105 has also been implemented. This step was used to choose the cross-sectional shape of the micro-beams and the associated transverse dimensions before moving on to production.

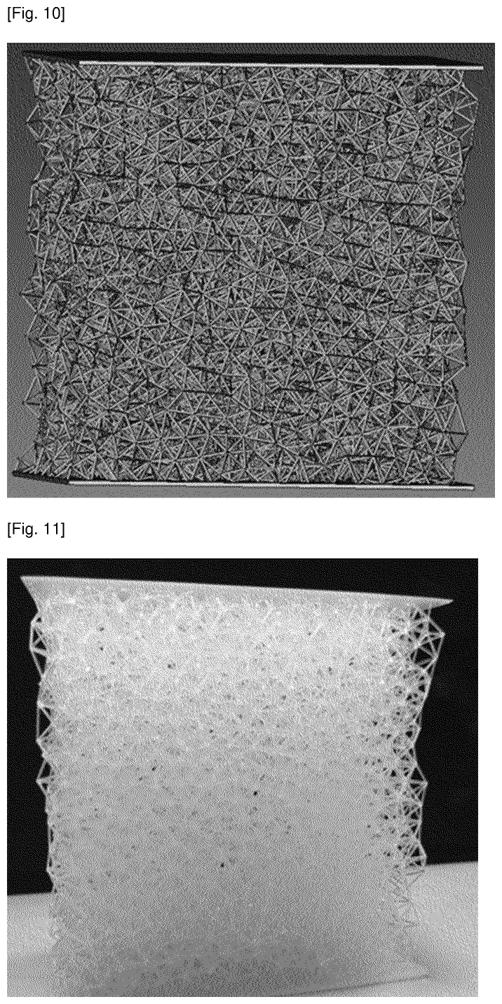

The three-dimensional amorphous micro-lattice architecture obtained at the end of this step is shown in FIG. 10.

It is a parallelepipedic architecture with dimensions of 100×100×50 mm³, made up of 17938 micro-beams of (roughly) identical diameters, and worth 500 pm. This type of sample (parallelepiped) is particularly suitable for compression testing. To do this, the step 105 used the Python FreeCAD (CAD) library to generate cylindrical micro-beams. The diameter of each micro-beam was chosen to be 1 mm. The software used to visualize this representation is FreeCAD. As may be seen in FIG. 10, upper and lower plates have been added to the micro-lattice in FreeCAD for fabrication and compression testing of the architecture. It was then produced using additive manufacturing. The 3D printer used for this is a FormLabs Form3 printer. The resin (material used to form the micro-lattice) used is Clear V4 resin.

FIG. 11 shows the final architecture obtained.

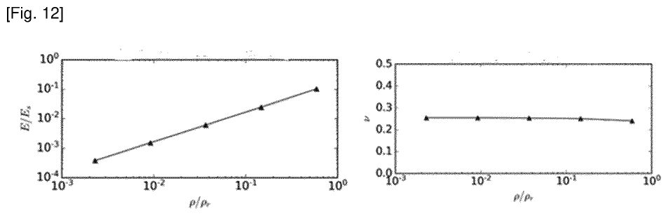

The mechanical behavior of the architecture shown in FIG. 11 could be simulated numerically, using numerical homogenization. This behavior is shown in FIG. 12.

The figure on the left shows the evolution of the ratio of the Young's modulus E of the micro-lattice to the Young's modulus E_{S} of the solid material as a function of the ratio of the density ρ of the micro-lattice to the density ρ_{S} of the solid material. The x-axis and y-axis are logarithmic. The straight line thus represented has a slope of ⅙. This value corresponds to the maximum value theoretically predicted for an isotropic porous material. This predicted theoretical value may be found in the article by G. Gurner and M. Durand: Stiffest elastic networks, Proceedings of the Royal Society A, 470, 20130611. This ensures maximum rigidity.

The figure on the right shows the Poisson's ratio v as a function of the ratio of the density p of the micro-lattice to the density ρ_{S} of the solid material. The Poisson's ratio is relatively constant at approximately 0.25. This is the value expected in an isotropic porous material with maximum rigidity. See the article by G. Gurner and M. Durand: Stiffest elastic networks, Proceedings of the Royal Society A, 470, 20130611.

The calculations carried out therefore demonstrate that an architecture with optimum mechanical properties may be obtained, in this case in terms of rigidity.

Furthermore, the applicant considers that the same will apply to the hardness (which may be characterized by the ratio of the elastic limit to the density) of the architecture thus obtained. Indeed, it has been shown that, in a micro-lattice where the micro-beams are arranged periodically, the shear bands play a role similar to that played by dislocations in a crystalline solid: their appearance favors plastic deformation (plastic deformation is the deformation obtained beyond the elastic limit) and consequently reduces performance in terms of hardness. This phenomenon may be transposed to the micro-lattice with amorphous architecture which is obtained with the method according to the invention. Such a micro-lattice prevents the existence of dislocations and may therefore only improve performance in terms of hardness. See the article by Pham, M. S., Liu, C., Todd, I., & Lertthanasarn, J. 2019. Damage-tolerant architected materials inspired by crystal microstructure, Nature, 565 (7739), 305 311; which concerns a periodically arranged micro-lattice architecture.

The present invention therefore offers a new way of generating an amorphous three-dimensional micro-lattice architecture without starting from a periodic lattice, and which therefore exhibits a lack of order at medium and long range. The mechanical behavior is therefore generally isotropic. In addition, the mechanical performance obtained is optimal. In contrast to the current prior art, there is no longer a trade-off between isotropy and mechanical performance. The micro-lattice defined in the context of the invention allows to achieve both.

The invention also relates to an amorphous three-dimensional architecture of the micro-lattice type, the micro-lattice being formed of micro-beams connected to each other by nodes and wherein each micro-beam forms one side of a triangle connecting the nodes closest to each other with an average connectivity of the nodes greater than or equal to twelve.

Once again, it should be remembered that an amorphous architecture of the micro-lattice type is, on the one hand, a random architecture, i.e. with no preferential directions, and, on the other hand, one wherein the micro-beams are of homogeneous length. In this way, the statistical distribution of the length of the micro-beams may have a standard deviation to mean ratio of less than or equal to 0.3, advantageously less than or equal to 0.2 and even more advantageously less than or equal to 0.15 or even less than or equal to 0.1. Each micro-beam may take the form, for example, of a cylinder of a given diameter. The choice of cylinder diameter allows the density of the architecture to be adjusted.

Advantageously, this architecture is obtained by implementing the method according to the invention. In particular, the method involves the design step 100 involving the implementation of steps 101 to 104 followed by the production step 200.

1. A method for producing an amorphous three-dimensional architecture of the micro-lattice type formed of micro-beams connected together by nodes, comprising the following steps:
A) performing (100) a computer-implemented design step consisting, on the basis of a three-dimensional random arrangement (INIT) of non-deformable beads of given diameters, in:
a) producing (101) a three-dimensional random compact stack of said beads,
b) for each bead in the three-dimensional random compact stack, determining (102) the coordinates of the center of the bead and then associate these coordinates with those of a node,
c) performing (103) a triangulation with the nodes thus defined so that each triangle is defined with the nodes closest to each other, then, associating two nodes connected by one side of a triangle to a micro-beam to define the micro-lattice,
d) selecting (104) a sub-domain of the micro-lattice obtained in step c), this sub-domain not comprising the nodes located at the edge of this micro-lattice, in order to define the amorphous three-dimensional micro-lattice architecture,
the design step involving an average connectivity of the nodes of the micro-lattice greater than or equal to twelve,
the design step also defining a shape and associated transverse dimensions for each micro-beam, and then:
B) producing (200) the architecture designed in step A).

2. The method according to claim 1, wherein step A) is implemented using a random arrangement of beads of identical diameters.

3. The method according to claim 1, wherein step a) is implemented by a Lubachevsky-Stillinger algorithm, referred to as force bias algorithm, an algorithm derived therefrom or any succession of these different algorithms.

4. The method according to claim 1, wherein the triangulation carried out in step c) is a Delaunay triangulation.

5. The method according to claim 1, further comprising a step (105), implemented after step d) and consisting in producing a lattice of the micro-lattice obtained in step d) before implementing step B).

6. The method according to claim 5, wherein step B) is produced by additive manufacturing.

7. An amorphous three-dimensional architecture of the micro-lattice type, the micro-lattice being formed of micro-beams connected to one another by nodes and wherein each micro-beam forms one side of a triangle connecting the nodes closest to one another with an average connectivity of the nodes greater than or equal to twelve.

8. The architecture according to claim 7, wherein the statistical distribution of the length of the micro-beams has a standard deviation to mean ratio of less than or equal to 0.3.

9. The architecture according to claim 7, wherein the statistical distribution of the length of the micro-beams has a standard deviation to mean ratio of less than or equal to 0.2.

10. The architecture according to claim 7, wherein each micro beam is in the form of a cylinder of given diameter.
